(19) United States
(12) Patent Application Publication
(10) Pub. No.: US 2014/0363658 A1
(43) Pub. Date: Dec. 11, 2014

(54) ALUMINUM ALLOY, ALUMINUM ALLOY RESIN COMPOSITE AND METHOD OF PREPARING THE SAME

(71) Applicants: SHENZHEN BYD AUTO R&D COMPANY LIMITED, Shenzhen (CN); BYD COMPANY LIMITED, Shenzhen (CN)

(72) Inventors: Jian SUN, Shenzhen (CN); Juan ZENG, Shenzhen (CN); Jun CHENG, Shenzhen (CN)

(21) Appl. No.: 14/466,927

(22) Filed: Aug. 22, 2014

Related U.S. Application Data
(63) Continuation of application No. PCT/CN2012/082043, filed on Sep. 26, 2012.

(30) Foreign Application Priority Data
Feb. 24, 2012 (CN) 201210043634.6

(51) Int. Cl. C25D 11/24; C25D 11/18; C08J 5/00

(52) U.S. Cl. CPC C25D 11/24; C08J 5/00; C25D 11/18; C08J 2381/04; C08K 7/14
USPC 428/307.3; 205/50; 205/223; 216/39

(57) ABSTRACT

An aluminum alloy, an aluminum alloy resin composite, a method of preparing aluminum alloy, and a method of preparing aluminum alloy-resin composite are provided. The aluminum alloy may comprise: an aluminum alloy substrate; and an oxide layer formed on the surface of the aluminum alloy substrate. The oxide layer comprises an outer surface and an inner surface. The outer surface contains corrosion pores having an average diameter of about 200 nm to about 2000 nm; and the inner surface contains nanopores having an average diameter of about 10 nm to about 100 nm.

### CROSS-REFERENCE TO RELATED APPLICATION

This application is a continuation of International Patent Application No. PCT/CN2012/082043, filed Sep. 26, 2012, which claims priority to and benefits of Chinese Patent Application Serial No. 201210043634.6, filed with the State Intellectual Property Office of P. R. China on Feb. 24, 2012. The entire content of the above applications are incorporated herein by reference.

### FIELD

The present disclosure relates to the field of metal-plastic molding, and more particularly to an aluminum alloy, an aluminum alloy resin composite, a method of preparing aluminum, and a method of preparing aluminum alloy-resin composite.

### BACKGROUND

In the fields of manufacture of articles such as automobiles, household appliances and industrial machines, a metal and a resin need to be firmly bonded together. According to conventional methods, an adhesive is used at normal temperature or under heating to integrally bond a metal and a synthetic resin. Alternatively, a resin with high strength may also be bonded to a magnesium alloy, an aluminum alloy, or ferroalloys such as stainless steel directly without an adhesive.

Nano molding technology (NMT) is a technique of integrally bonding a metal and a resin, which allows the resin to be directly injection molded on a surface of a metal sheet by nano molding the surface of the metal sheet so as to obtain a metal-resin integrally molded product. For effective bonding of a metal and a resin, NMT may replace commonly used insert molding or zinc-aluminum or magnesium-aluminum die casting so as to provide a metal-resin integrally molded product with low cost and high performance. Compared with the bonding technology, NMT may reduce the weight of the final product, ensure excellent strength of the mechanical structure, high processing rate, and high output, and allow more appearance decoration methods, thereby applicable to vehicles, IT equipment, and 3C products.

### SUMMARY

Embodiments of the present disclosure seek to solve at least one of the problems existing in the prior art and, particularly, the technical problems of weak bonding force between the aluminum alloy and resin in an aluminum alloy-resin composite. And the present disclosure aims to provide a method of preparing an aluminum alloy-resin composite with strong bonding force between the aluminum alloy and resin, thereby improving massive production and reducing pollution.

According to a first aspect of the present disclosure, there is provided an aluminum alloy comprising: an aluminum alloy substrate; and an oxide layer formed on a surface of the aluminum alloy substrate, and the oxide layer comprises an outer surface and an inner surface; wherein, the outer surface contains corrosion pores having an average diameter of about 200 nm to about 2000 nm; and the inner surface contains nanopores having an average diameter of about 10 nm to about 100 nm.

According to a second aspect of the present disclosure, there is provided an a method of preparing the aluminum alloy described above, comprising the steps of: S1: anodizing a surface of an aluminum alloy to form an oxide layer on the surface, in which the oxide layer is formed with nanopores having an average diameter of about 10 nm to about 100 nm; S2: immersing the resulting aluminum alloy in step S1 in an etching solution, to form corrosion pores in an outer surface of the oxide layer, in which the corrosion pores have an average diameter of about 200 nm to about 2000 nm.

According to a third aspect of the present disclosure, there is provided an aluminum alloy resin composite comprising: an aluminum alloy part described above; and a resin part, which is fixed to the surface of the aluminum ally part. Part of the resin part is filled in the nanopores and corrosion pores of the aluminum alloy part.

According to a fourth aspect of the present disclosure, there is provided a method of preparing an aluminum alloy-resin composite described above comprising the steps of: S1: anodizing a surface of an aluminum alloy to form an oxide layer on the surface, in which the oxide layer is formed with nanopores having an average diameter of about 10 nm to about 100 nm; S2: immersing the resulting aluminum alloy in step S1 in an etching solution, to form corrosion pores in an outer surface of the oxide layer, in which the corrosion pores have an average diameter of about 200 nm to about 2000 nm; and S3: injection molding a resin onto the surface of the resulting aluminum alloy substrate in step S2 in a mold to obtain the aluminum alloy-resin composite.

A two-layer spatial pore structure may be formed on the surface of aluminum alloy, by means of the method according to embodiments of present disclosure, an aluminum oxide layer may be formed on the surface of aluminum alloy, and the aluminum oxide layer possess nanopores with excellent properties. By means of the technical solutions according to embodiments of present disclosure, nanopores having an average diameter of about 10 to about 100 nm may be formed, providing improved connectivity with resin. Meanwhile, by means of further corrosion, corrosion pores may be formed on the outer surface of the aluminum oxide layer and to be contacted with a resin of the aluminum oxide layer. The corrosion pores may have a larger diameter than nanopores. By means of the technical solutions according to embodiments of present disclosure, nanopores having an average diameter of about 200 nm to about 2000 nm may be formed on the outer surface, which enhances the connectivity of a resin with the aluminum alloy.

In the course of following molding step, a resin may penetrate into the pores in the inner layer through the relative bigger pores on the outer surface of aluminum alloy, which makes molding easier. According to embodiments of present disclosure, aluminum alloy may be joined to a resin tightly without additional bonding, improving the strength of the structure. According to embodiments of present disclosure, there is little influence on the size of metal substrate and the appearance of aluminum alloy, and relatively less heat is produced in the course of processing. Meanwhile, the resin may be easily injection molded into the corrosion pores with larger diameters on the surface, and there is no particular requirement on the resin. The present technical solution may be used widely, is environment-friendly, and may be adopted for massive production.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions taken in conjunction with the drawings in which:

FIG. 1 shows the presence of two-layer spatial pore structure in the aluminum oxide layer prepared in one embodiment of present disclosure;

FIG. 2 shows a scanning electron microscopy diagram of aluminum alloy sheet surface after surface treatment 1 in Example 1; and

FIGS. 3a and 3b show scanning electron microscopy diagrams of aluminum alloy sheet surface after surface treatment 2 in Example 1.

### DETAILED DESCRIPTION

Reference will be made in detail to embodiments of the present disclosure. The embodiments described herein are explanatory, illustrative, and used to generally understand the present disclosure. The embodiments shall not be construed to limit the present disclosure.

According to a first aspect of the present disclosure, there is provided an aluminum alloy comprising: an aluminum alloy substrate; and an oxide layer formed on the surface of the aluminum alloy substrate, and the oxide layer comprises an outer surface and an inner surface; wherein, the outer surface contains corrosion pores having an average diameter of about 200 nm to about 2000 nm; and the inner surface contains nanopores having an average diameter of about 10 nm to about 100 nm. The aluminum alloy may have well combination with resin, and is easy to be massively produced without pollution.

According to an embodiment of present disclosure, the corrosion pores have an average diameter of about 200 nm to about 1000 nm. According to a further embodiment, the corrosion pores have an average diameter of about 400 nm to about 1000 nm. According to an embodiment, the nanopores have an average diameter of about 20 nm to about 80 nm. According to a further embodiment, the nanopores have an average diameter of about 20 nm to about 60 nm. The structure of the two-layered pores contributes to the direct injection of resin when molding and improves the bonding of resin with the alloy.

According to an embodiment of present disclosure, the corrosion pores have an average depth of about 0.5 μm to about 9.5 μm. According to a further embodiment, the corrosion pores have an average depth of about 0.5 μm to 5 μm. The structure of the corrosion pores contributes to the penetration of injected resin.

According to embodiments of present disclosure, the corrosion pores are communicated with the nanopores. The structure of the two-layered pores contributes to the direct injection of resin and molding, improving the bonding between the resin and the alloy.

According to an embodiment of present disclosure, the oxide layer has a thickness of about 1 μm to about 10 μm. According to a further embodiment, the oxide layer has a thickness of about 1 μm to about 5 μm. The oxide layer may have an improved bonding with the aluminum alloy substrate, and optimize the structure of corrosion pores, thus make it easy to create optimized corrosion pores.

According an embodiment of the present disclosure, the nanopores have an average depth of about 0.5 μm to about 9.5 μm. According to a further embodiment, the nanopores have an average depth of about 0.5 μm to 5 μm. The structure of the nanopores improves the filling of melted resin in the nanopores, ensuring that the resin penetrates the full depth of the nanopores, decreasing the connection area between the resin and the oxide layer, removing voids or gaps in the nanopores, and enhancing the connectivity.

According to a second aspect of the present disclosure, a method of preparing an aluminum alloy described above is provided. The method comprises steps of:

S1: Anodizing a Surface of an Aluminum Alloy to Form an Oxide Layer, in which Nanopores are Formed.

According to embodiments of present disclosure, in this step, the aluminum alloy may be pre-treated and may be subjected to anodization treatment. An oxide layer may be formed on the surface of the aluminum alloy, and the oxide layer may include nanopores. According to embodiments of present disclosure, the method for the anodization treatment is known to the skilled person in the art. According to embodiments of present disclosure, the anodization treatment may comprise: providing an aluminum alloy, which may be pre-treated prior to this step, as an anode in a H₂SO₄ solution with a concentration of about 10 wt % to about 30 wt %; and electrolyzing the aluminum alloy at a temperature of about 10° C. to about 30° C. at a voltage of about 10V to about 100V for about 1 minute to about 40 minutes to form the oxide layer with a thickness of about 1 μm to about 10 μm on the surface of the aluminum alloy. According to embodiments of present disclosure, any apparatus known for the anodization treatment may be applied in the present disclosure. For example according to an embodiment of present disclosure, an anodization tank may be applied. According to embodiments of the present disclosure, the oxide layer formed by means of anodization treatment may have a thickness of about 1 μm to about 10 μm or about 1 μm to about 5 μm.

According to an embodiment of the present disclosure, the nanopores of the oxide layer may have an average diameter of about 10 nm to about 100 nm. According to a further embodiment, the nanopores of the oxide layer may have an average diameter of about 20 nm to about 80 nm. According to a still further embodiment, the nanopores of the oxide layer may have an average diameter of about 20 nm to about 60 nm. According to an embodiment of the present disclosure, the nanopores may have a depth of about 0.5 μm to about 9.5 μm. According to a further embodiment, the nanopores may have a depth of about 0.5 μm to about 5 μm. It was founded by the inventors the nanopores provide improved the bonding force between the oxide layer and the resin.

S2: Immersing the Resulting Aluminum Alloy in Step S1 in an Etching Solution, to Form Corrosion Pores in an Outer Surface of the Oxide Layer.

According to embodiments of present disclosure, in this step, the resulting aluminum alloy substrate in step S1 may be immersed in an etching solution, forming corrosion pores with an average diameter of about 200 nm to about 2000 nm in the outer surface of the oxide layer formed on the aluminum alloy substrate in step S 1.

In this step, an etching solution is used to treat the resulting aluminum alloy substrate in step S1. Corrosion pores may be formed in an outer surface of the oxide layer, and the diameter of the corrosion pores is larger than that of the nanopores. The type and concentration of the etching solution is not specially limited, as long as the etching solution comprises a solution being corrosive to the oxide layer. According to embodiments of present disclosure, the etching solution is an acid/alkaline etching solution with a pH of about 10 to about 13. According to embodiments of present disclosure, the etching solution may be an alkaline solution with a pH of about 10 to about 13 of sole alkali or mixture of several alkalis. According to embodiments of present disclosure, the etching solution may comprise an aqueous solution containing at least one selected from a group consisting of Na₂CO₃, NaHCO₃, NaOH, NaH₂PO₄, Na₂HPO₄, Na₃PO₄, Na₂SO₃ and Na₂B₄O₇.

According to embodiments of present disclosure, the alkaline solution is an aqueous solution containing Na₂CO₃ and/or NaHCO₃. According to embodiments of present disclosure, in the alkaline solution, Na₂CO₃ and/or NaHCO₃ have a mass percent concentration of about 0.1 wt %-15 wt % respectively. According to embodiments of present disclosure, in the alkaline solution, Na₂CO₃ and/or NaHCO₃ have a mass percent concentration of about 0.1 wt %-10 wt % respectively. According to embodiments of present disclosure, the etching solution may be a mixture of a soluble alkali with a soluble hydrophosphate or dihydrogen phosphate. According to embodiments of present disclosure, the soluble alkali may be a strong alkali. According to embodiments of present disclosure, the dihydrogen phosphate is at least one selected from a group consisting of sodium dihydrogen phosphate, potassium dihydrogen phosphate, ammonium dihydrogen phosphate, and aluminum dihydrogen phosphate, and the soluble alkali is at least one selected from a group consisting of sodium hydroxide and potassium hydroxide.

Then, with the combination of dihydrogen phosphate and alkali, the corrosion pores are formed and distributed evenly on the surface of the oxide layer with uniform diameters. Pore structure may provide a better bonding between the resin layer with the aluminum alloy substrate, resulting in a better tensile strength and a better integral joining of the aluminum alloy-resin composite. According to an embodiment of present disclosure, the dihydrogen phosphate has a concentration of about 50 wt % to about 99 wt %, and the soluble alkali has a concentration of about 1 wt % to about 50 wt %. According to a further embodiment, the dihydrogen phosphate has a concentration of about 60 wt % to about 99 wt %, and the soluble alkali has a concentration of about 1 wt % to about 40 wt %.

Further, the etching solution may be at least one of ammonia solution, hydrazine aqueous solution, hydrazine derivatives aqueous solution, water-soluble amine compound aqueous solution and NH₃—NH₄Cl aqueous solution and the like. According to an embodiment of the present disclosure, at step S2, the resulting aluminum alloy in step S1 is repeatedly immersed in an etching solution for, for example, 2 to 10 times. Each immersing lasts for about 1 minute to about 60 minutes. The aluminum alloy is cleaned with water after each immersing by, for example washing with de-ionized water. According to an embodiment of present disclosure, the cleaning may comprise placing the article to be cleaned in a washing tank and stand for about 1 minute to 5 minutes, and may comprise washing the article to be cleaned in a washing tank for about 1 minute to 5 minutes.

As mentioned before, prior to the treatment of step S 1, the aluminum alloy may be subjected to a pretreatment on the surface, which generally comprises mechanical burnishing or mechanical lapping to remove visible foreign matters from the surface, and degreasing and washing the aluminum alloy to remove processing oil adhered to the metal surface. Preferably, pretreatment may comprise burnishing the surface of an aluminum alloy using, for example, a sand paper of about 100 mesh to about 400 mesh or using a polishing machine, to create small pores of microns. According to embodiments of present disclosure, the burnished aluminum alloy may be subjected to, sequentially, oil removing, a first washing with water, alkali etching, a second washing with water, neutralizing, and a third washing with water.

According to embodiments of present disclosure, the aluminum alloy may be cleaned by means of ultrasonic wave using any known solvent for about 0.5 hour to about 2 hours to remove oily dirt from the surface of aluminum alloy, place the aluminum alloy in an acid/alkali aqueous solution, and wash the surface again under ultrasonic wave. The types of the solvents and acid/alkali aqueous solution are not limited, the solvent used may be ethanol or acetone, and the acid/alkali aqueous solution may be at least one selected from a group consisting of hydrochloric acid, sulphuric acid, sodium hydroxide, potassium hydroxide and the like.

According to embodiments of present disclosure, the aluminum alloy is subjected to oil removing treatment using water-free ethanol to remove oil from the surface, and then washed using water. Then, the washed aluminum alloy is immersed in a sodium hydroxide solution at a concentration of about 30-70 g/L and at a temperature of about 40° C. to about 80° C. to alkali etch the aluminum alloy for about 1-5 minutes, and washed using deionized water. Then, the aluminum alloy is neutralized using a 10-30 wt % HNO₃ to remove trace alkali solution, and washed using deionized water. Thus, a pore with a size of microns may be formed on the surface of aluminum alloy. According to embodiments of the present disclosure, the diameter of the pore may be about 1-10 μm.

There are no special limitations to the aluminum alloy used in the present disclosure. Examples may include Industry-Standard 1000-7000 series, or various aluminum alloys of molded-class. The aluminum alloy in this disclosure may be commonly-used aluminum alloy with various shapes and structures, which is not limited by the present disclosure. The various shapes and structures of the aluminum alloy may be achieved by mechanical processing.

According to a third aspect of the present disclosure, there is provided an aluminum alloy resin composite comprising: an aluminum alloy part as described above; and a resin part, which is fixed to the surface of the aluminum ally part. Part of the resin part is filled in the nanopores and corrosion pores of the aluminum alloy part.

There is no special limitation to the resin used in present invention, which may be any resin capable of joining with aluminum alloy. In one embodiment, the resin may be a thermoplastic resin. According to embodiments of the present disclosure, the thermoplastic resin includes a mixture of a main resin and a polyolefin resin. According to embodiments of the present disclosure, the main resin may include non-crystalline resin, which has a surface gloss and a toughness both superior to those of the highly crystalline resins in the prior art. The main resin is used as an injection molding material. The polyolefin resin may have a melting point of about 65° C. to about 105° C. Therefore, injection molding at a specific mound temperature may not be required during the molding, subsequent annealing treatment may also not be required, the molding process may be simplified, and it may be ensured that the obtained metal-resin composite has a high mechanical strength and good surface treatment characteristics, allowing various surface decorations of a plastic article and meeting the diverse requirements of customers.

According to embodiments of present disclosure, it has been found by the inventors through many experiments that in the present disclosure, by using a polyolefin resin with a melting point of about 65° C. to about 105° C. in the non-crystalline main resin, the flowing capability of the resin in the nanoscale micropore in the surface of the metal sheet may be enhanced, thus ensuring strong adhesive force between the metal and the plastic as well as high mechanical strength of the metal-resin composite. Preferably, based on 100 weight parts of the thermoplastic resin, the amount of the main resin is about 70 weight parts to about 95 weight parts, and the amount of the polyolefin resin is about 5 weight parts to about 30 weight parts.

It has also been found by the inventors that the flowing capability of the resin may be enhanced by including a flow improver in the thermoplastic resin, thus further enhancing the adhesive force between the metal and the plastic as well as the injection molding performance of the resin. Preferably, based on 100 weight parts of the thermoplastic resin, the thermoplastic resin further contains about 1 weight part to about 5 weight parts of a flow improver. Preferably, the flow improver is a cyclic polycarbonate.

As mentioned before, the resin used in present disclosure may include non-crystalline resin. According to embodiments of present disclosure, the main resin includes a mixture of polyphenylene ether (PPO) and polyphenylene sulfide (PPS). According to one embodiment of present disclosure, in the main resin, the weight ratio of polyphenylene ether to polyphenylene sulfide is about 3:1 to about 1:3, preferably about 2:1 to about 1:1. According to embodiments of present disclosure, the main resin includes a mixture of polyphenylene oxide and a polyamide. According to one embodiment of present disclosure, in the main resin, the weight ratio of polyphenylene oxide to the polyamide is about 3:1 to about 1:3, preferably about 2:1 to about 1:1. According to embodiments of present disclosure, in the main resin, the main resin includes a polycarbonate, which may be linear chain polycarbonate or branched polycarbonate.

According to embodiments of present disclosure, the polyolefin resin has a melting point of about 65° C. to about 105° C., preferably the polyolefin resin may be a grafted polyethylene. Preferably, the grafted polyethylene may have a melting point of about 100° C. to about 105° C.

The resin used in present disclosure may further comprise other additives, and there is no special limitation to the additives. For example, the resin may comprise a filler. And there is no special limitation to the filler, which may be, for example, fiber filler or powder inorganic filler. The fiber filler may include at least one selected from a group consisting of fiberglass, carbon fiber and aromatic polyamide fiber. And the powder inorganic filler may include at least one selected from a group consisting of calcium carbonate, magnesium carbonate, silica, heavy barium sulfate, talcum powder, glass and clay. According to embodiments of present disclosure, based on 100 weight parts of the main resin, the content of the fiber filler is 50-150 weight parts and the content of the powder filler is 50-150 weight parts. Then the resin has a linear expansion coefficient similar to the aluminum alloy both in horizontal and vertical directions.

According to a fourth aspect of the present disclosure, there is provided a method of preparing an aluminum alloy-resin composite described above comprising the steps of: preparing an aluminum alloy substrate according to the method descried above; and

S3: Injection Molding a Resin onto the Surface of the Resulting Aluminum Alloy Substrate in Step S2 in a Mold to Obtain the Aluminum Alloy-Resin Composite.

According to embodiments of present disclosure, in this step, the resulting aluminum alloy substrate after the treatments in steps S1 and S2 may be placed in a mold, and a resin composition may be injected into the mold to be combined with the aluminum alloy substrate, thereby forming an aluminum alloy-resin composite after molding treatment.

According to embodiments of present disclosure, the resin used in present disclosure may be prepared by mixing main resin and polyolefin resin. For example, the resin is prepared by mixing evenly a main resin and a polyolefin resin, and then granulation with twin-screw extruding machine.

According to embodiments of present disclosure, a flow improver and a filler may be added to the main resin and mixed evenly. Thus the obtained resin has a linear expansion coefficient similar to the aluminum alloy both in horizontal and vertical directions.

According to embodiments of present disclosure, the conditions to carry out the injection molding are not limited. For example, according to one embodiment of present disclosure, the condition of injection molding may be: mold temperature 50 to 300° C., nozzle temperature 200-450° C., pressure maintaining time 1-50 s, injection pressure 50-300 MPa, injection time 1-30 s, delay time 1-30 s, and cooling time 1-60 s. According to one embodiment of present disclosure, the condition of injection molding may be: mold temperature 80 to 200° C., nozzle temperature 200-350° C., pressure maintaining time 1-10 s, injection pressure 90-140 MPa, injection time 3-10 s, delay time 15-30 s, and cooling time 15-25 s. Then the surface of the prepared composite may have a resin with a depth of 0.5-10 mm.

The preparation method of the present disclosure is simple, which simplifies significantly the production process, when compared with existing adhesive technology, and shorten the corrosion time when compared with the existing amine substance, thereby shortening the production time, and significantly reducing the process complexity. These benefits may be provided by directly injection molding after using the process method of the present disclosure. At the same time, the alloy-resin composite provided by the preparation method of the present disclosure has a combination between the resin layer and the aluminum alloy substrate, and has improved tensile shear strength.

According to another aspect of present disclosure, an aluminum alloy-resin composite is obtained by the method described above. According to embodiments of present disclosure, the aluminum alloy-resin composite comprises an aluminum alloy substrate and a resin layer, in which a resin forming the resin layer is filled in nanopores and corrosion pores. The resin may be any known resin, which can be bonded to the aluminum alloy.

In order to make the technical problem, the technical solution and the advantageous effects of the present disclosure more clear, the present disclosure further describes embodiments below in details with reference to examples thereof. It would be appreciated that particular examples described herein are merely used to understand the present disclosure. The examples shall not be construed to limit the present disclosure. The raw materials used in the examples and the comparative examples are all commercially available, without special limits.

### Example 1

In this example, an aluminum alloy resin composite was prepared.

1. Pretreatment:

A commercially available A5052 aluminum alloy plate with a thickness of 1 mm was cut into 15 mm×80 mm rectangular sheets, which were then polished in a polishing machine, and cleaned with water-free ethanol, and then immersed in a 40 g/L NaOH aqueous solution. After 2 minutes, the rectangular sheets were washed with water and dried to obtain pretreated aluminum alloy sheets.

2. Surface Treatment 1:

Each aluminum alloy sheet as an anode was placed in an anodizing bath containing a 20 wt % H₂SO₄ solution, the aluminum alloy was electrolyzed at a voltage of 20V at 18° C. for 10 min, and then the aluminum alloy sheet was blow-dried.

The cross section of the aluminum alloy sheet after the surface treatment 1 was observed by a metalloscope, to show that an aluminum oxide layer with a thickness of 5 μm was formed on the surface of the electrolyzed aluminum alloy sheet. The surface of the aluminum alloy sheet after the surface treatment 1 was observed by an electron microscope (see FIG. 2), to show that nanopores with an average diameter of about 40 nm to about 60 nm and a depth of 1 μm was formed in the aluminum oxide layer.

3. Surface Treatment 2

100 ml aqueous solution containing 10 wt % Na₂CO₃ (pH=12.2) was prepared in a beaker. The aluminum alloy sheet after step (2) was immersed in the sodium carbonate solution at 20° C., taken out after 5 min, and placed in a beaker containing water to be immersed for 1 min. The process was repeated for 5 times. After water immersing for the last time, the aluminum alloy sheet was blow-dried.

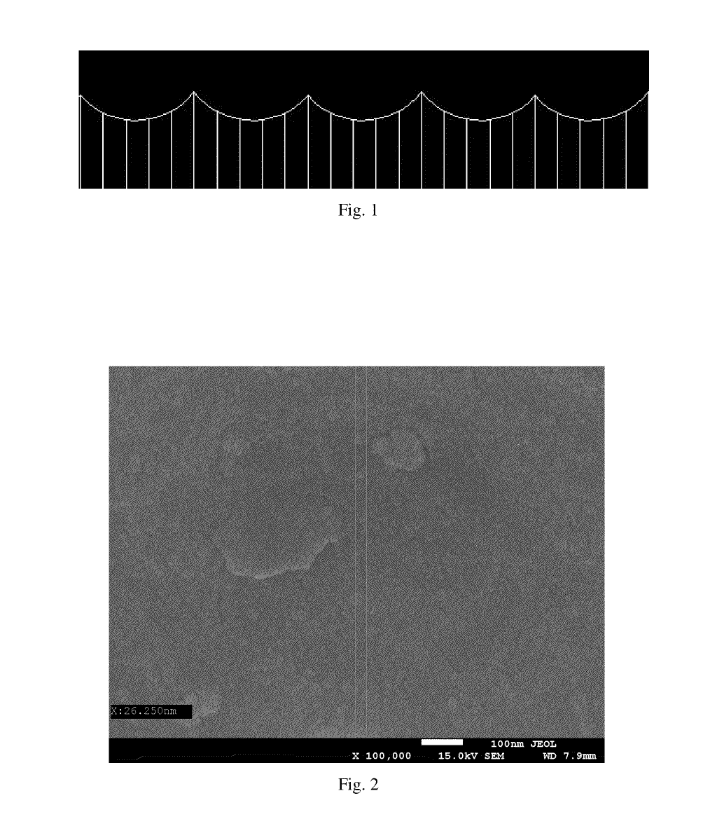

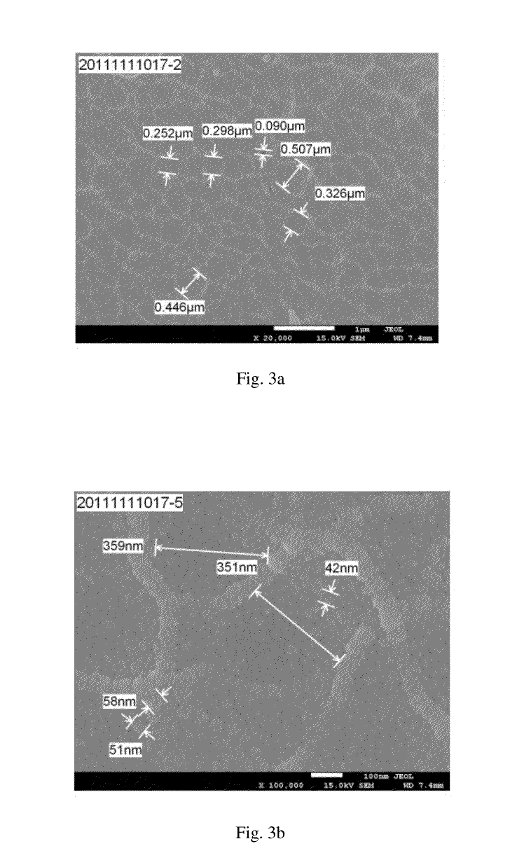

The surface of the aluminum alloy sheet after the surface treatment 2 was observed by an electron microscope (see FIGS. 3a and 3b), to show that corrosion pores with an average diameter of 300 nm to 1000 nm and a depth of 4 μm was formed in the surface of the immersed aluminum alloy sheet. It may also be observed that there was a double-layer, three-dimensional pore structure in the aluminum oxide layer similar to the structure shown in FIG. 1, in which the corrosion pores were communicated with the nanopores.

4. Molding:

The dried aluminum alloy piece was inserted into an injection mold. A resin composition containing a polyphenylene sulfide (PPS) resin and 30 wt % fiberglass was injection molded. The aluminum alloy resin composite, which was a firmly bonding of aluminum alloy and resin composite, was obtained after being demolded and cooled.

### Example 2

In this example, an aluminum alloy resin composite was prepared by a method which was substantially the same as the method in Example 1, with the following exceptions.

In the step of surface treatment 1, each aluminum alloy sheet as an anode was placed in an anodizing bath containing a 20 wt % H₂SO₄ solution, the aluminum alloy was electrolyzed at a voltage of 15V at 18° C. for 10 min, and then the aluminum alloy sheet was blow-dried.

It was observed that a layer of aluminum oxide film having a thickness of about 5 μm was formed after electrolysis, and nanopores having diameters of 20-40 nm were formed in the aluminum oxide layer. And it was observed that after surface treatment 2, corrosion pores with diameters of 300-1000 nm and a depth of 4 μm were formed in the surface of the immersed aluminum alloy sheet. It may also be observed that there was a double-layer, three-dimensional pore structure in the aluminum oxide layer similar to the structure shown in FIG. 1, in which the corrosion pores were communicated with the nanopores. And an aluminum alloy resin composite was prepared.

### Example 3

In this example, an aluminum alloy resin composite was prepared by a method which was substantially the same as the method in Example 1, with the following exceptions.

In the step of surface treatment 1, each aluminum alloy sheet as an anode was placed in an anodizing bath containing a 20 wt % H₂SO₄ solution, the aluminum alloy was electrolyzed at a voltage of 40V at 18° C. for 10 min, and then the aluminum alloy sheet was blow-dried.

It was observed that a layer of aluminum oxide film having a thickness of about 5 μm was formed after electrolysis, and nanopores having diameters of 60-80 nm and a depth of 1 μm were formed in the aluminum oxide layer. And it was observed that after surface treatment 2, corrosion pores with diameters of 300-1000 nm and a depth of 4 μm were formed in the surface of the immersed aluminum alloy sheet. It may also be observed that there was a double-layer, three-dimensional pore structure in the aluminum oxide layer similar to the structure shown in FIG. 1, in which the corrosion pores were communicated with the nanopores. And an aluminum alloy resin composite was prepared.

### Example 4

In this example, an aluminum alloy resin composite was prepared by a method which was substantially the same as the method in Example 1, with the following exceptions.

In the step of surface treatment 1, each aluminum alloy sheet as an anode was placed in an anodizing bath containing a 20 wt % H₂SO₄ solution, the aluminum alloy was electrolyzed at a voltage of 20V at 18° C. for 15 min, and then the aluminum alloy sheet was blow-dried.

It was observed that a layer of aluminum oxide film having a thickness of about 7 μm was formed after electrolysis, and nanopores having diameters of 40-60 nm and a depth of 3 μm were formed in the aluminum oxide layer. And it was observed that after surface treatment 2, corrosion pores with diameters of 300-1000 nm and a depth of 4 μm were formed in the surface of the immersed aluminum alloy sheet. It may also be observed that there was a double-layer, three-dimensional pore structure in the aluminum oxide layer similar to the structure shown in FIG. 1, in which the corrosion pores were communicated with the nanopores. And an aluminum alloy resin composite was prepared.

### Example 5

In this example, an aluminum alloy resin composite was prepared by a method which is substantially the same as the method in Example 1, with the following exceptions.

In the step of surface treatment 1, each aluminum alloy sheet as an anode was placed in an anodizing bath containing a 20 wt % H₂SO₄ solution, the aluminum alloy was electrolyzed at a voltage of 15V at 18° C. for 15 min, and then the aluminum alloy sheet was blow-dried.

It was observed that a layer of aluminum oxide film having a thickness of about 7 μm was formed after electrolysis, and nanopores having diameters of 20-40 nm and a depth of 3 μm were formed in the aluminum oxide layer. And it was observed that after surface treatment 2, corrosion pores with diameters of 300-1000 nm and a depth of 4 μm were formed in the surface of the immersed aluminum alloy sheet. It may also be observed that there was a double-layer three-dimensional pore structure in the aluminum oxide layer similar to the structure shown in FIG. 1, in which the corrosion pores were communicated with the nanopores. And an aluminum alloy resin composite was prepared.

### Example 6

In this example, an aluminum alloy resin composite was prepared by a method which is substantially the same as the method in Example 1, with the following exceptions.

In the step of surface treatment 1, each aluminum alloy sheet as an anode was placed in an anodizing bath containing a 20 wt % H₂SO₄ solution, the aluminum alloy was electrolyzed at a voltage of 40V at 18° C. for 15 min, and then the aluminum alloy sheet was blow-dried.

It was observed that a layer of aluminum oxide film having a thickness of about 7 μm was formed after electrolysis, and nanopores having diameters of 60-80 nm and a depth of 3 μm were formed in the aluminum oxide layer. And it was observed that after surface treatment 2, corrosion pores with diameters of 300-1000 nm and a depth of 4 μm were formed in the surface of the immersed aluminum alloy sheet. It may also be observed that there was a double-layer, three-dimensional pore structure in the aluminum oxide layer similar to the structure shown in FIG. 1, in which the corrosion pores were communicated with the nanopores. And an aluminum alloy resin composite was prepared.

### Example 7

In this example, an aluminum alloy resin composite was prepared by a method which is substantially the same as the method in Example 2, with the following exceptions.

100 ml aqueous solution containing 5 wt % Na₂CO₃ with pH=11.9 was prepared in a beaker. The aluminum alloy sheet after step (2) was immersed in the sodium carbonate solution, taken out after 5 min, and placed in a beaker containing water to be immersed for 1 min. After 5 cycles, after water immersing for the last time, the aluminum alloy sheet was blow-dried.

It was observed that a layer of aluminum oxide film having a thickness of about 5 μm was formed after electrolysis, and nanopores having diameters of 20-40 nm and a depth of 3 μm were formed in the aluminum oxide layer. And it was observed that after surface treatment 2, corrosion pores with diameters of 300-600 nm and a depth of 2 μm were formed in the surface of the immersed aluminum alloy sheet. It may also be observed that there was a double-layer, three-dimensional pore structure in the aluminum oxide layer similar to the structure shown in FIG. 1, in which the corrosion pores were communicated with the nanopores. And an aluminum alloy resin composite was prepared.

### Example 8

In this example, an aluminum alloy resin composite was prepared by a method which is substantially the same as the method in Example 2, with the following exceptions.

100 ml aqueous solution containing 15 wt % NaHCO₃ with pH=10 was prepared in a beaker. The aluminum alloy sheet after step (2) was immersed in the sodium carbonate solution, taken out after 5 min, and placed in a beaker containing water to be immersed for 1 min. After 5 cycles, after water immersing for the last time, the aluminum alloy sheet was blow-dried.

It was observed that a layer of aluminum oxide film having a thickness of about 5 μm was formed after electrolysis, and nanopores having diameters of 20-40 nm and a depth of 3 μm were formed in the aluminum oxide layer. And it was observed that after surface treatment 2, corrosion pores with diameters of 300-600 nm and a depth of 2 μm were formed in the surface of the immersed aluminum alloy sheet. It may also be observed that there was a double-layer, three-dimensional pore structure in the aluminum oxide layer similar to the structure shown in FIG. 1, in which the corrosion pores were communicated with the nanopores. And an aluminum alloy resin composite was prepared.

### Comparative Example 1

### 1. Pretreatment

A commercially available A5052 aluminum alloy plate with a thickness of 1 mm was cut into 15 mm×80 mm rectangular sheets, which were then polished in a polishing machine, and cleaned with water-free ethanol, and then immersed in a 2 wt % NaOH aqueous solution. After 2 minutes, the rectangular sheets were washed with water and dried to obtain pretreated aluminum alloy sheets.

### 2. Surface-Treatment

Each aluminum alloy sheet was immersed into a hydrazine hydrate aqueous solution having a concentration of 5 wt % with pH=11.2. After 2 min at 50° C., the aluminum alloy sheet was taken out and washed with deionized water. The process was repeated for 30 times. The aluminum alloy sheet was then taken out and dried in a drying oven at 60° C.

### 3. Molding

The dried aluminum alloy piece was inserted into an injection mold. A resin composition containing a polyphenylene sulfide (PPS) resin and 30 wt % fiberglass was injection molded. The aluminum alloy-resin composite which is a firmly bonded structure of aluminum alloy and resin composite was obtained after being demolded and cooled.

### Comparative Example 2

### 1. Pretreatment

A commercially available A5052 aluminum alloy plate with a thickness of 1 mm was cut into 15 mm×80 mm rectangular sheets, which were then polished in a polishing machine, and cleaned with water-free ethanol, and then immersed in a 2 wt % NaOH aqueous solution. After 2 minutes, the rectangular sheets were washed with water and dried to obtain pretreated aluminum alloy sheets.

### 2. Surface-Treatment

Each aluminum alloy sheet as an anode was placed in an anodizing bath containing a 20 wt % H₂SO₄ solution, the aluminum alloy was electrolyzed at a voltage of 15V for 10 min, and then the aluminum alloy sheet was blow-dried.

### 3. Molding

The dried aluminum alloy piece was inserted into an injection mold. A resin composition containing a polyphenylene sulfide (PPS) resin and 30 wt % fiberglass was injection molded. The aluminum alloy-resin composite which was a firmly bonded structure of aluminum alloy and resin composite was obtained after being demolded and cooled.

Performance Test

The connectivity of the aluminum alloy and the resin: the aluminum alloy resin composites prepared in examples 1-8 and comparative examples 1-2 were fixed in a universal material testing machine to perform tensile test. The test results under maximum load can be regarded as the connectivity force value between the aluminum alloy and resin, the test results were summarized in Table 1 below.

TABLE 1

| | Thickness of | | | Diameter of | Depth of | |
|---|---|---|---|---|---|---|
| | oxide film | Diameter of | Depth of | corrosion | Nano Pore/ | |
| | layer/μm | nanopores/nm | nanopores/μm | pores/nm | μm | Combination/N |
| Example1 | 5 | 40-60 | 1 | 300-1000 | 4 | 1261 |
| Example2 | 5 | 20-40 | 1 | 300-1000 | 4 | 1229 |
| Example3 | 5 | 60-80 | 1 | 300-1000 | 4 | 1240 |
| Example4 | 7 | 40-60 | 3 | 300-1000 | 4 | 1211 |
| Example5 | 7 | 20-40 | 3 | 300-1000 | 4 | 1259 |
| Example6 | 7 | 60-80 | 3 | 300-1000 | 4 | 1236 |
| Example7 | 5 | 20-40 | 3 | 300-600 | 2 | 1222 |
| Example8 | 5 | 20-40 | 3 | 300-600 | 2 | 1255 |
| Comparative | | | | | | 357 |
| example 1 | | | | | | |
| Comparative | | | | | | 65 |
| example 2 | | | | | | |

It can be seen from Table 1 that the c=bonding between the resin and the aluminum alloy in the aluminum alloy-resin composite of the present disclosure can achieve up to 1211 N, showing the bonding is excellent. While the bonding between the resin and the aluminum alloy in comparative aluminum alloy-resin composite is only tens or hundreds of newton. The performance of the aluminum alloy-resin composite in the present disclosure provides significantly improved performance compared with the comparative examples. In addition, the resin molding process of the present disclosure is easier. The aluminum alloy in the present disclosure does not need additional bonding to be combined with the resin. Thus, the methods and structures disclosed herein have little effect on the size of the metal substrate and appearance of the aluminum alloy. At the same time, it is easier to inject mold resin directly into the corrosion holes with a bigger surface. It also has no specific requirement for the synthetic resin, and provides a wider range of applications. And there is minimum environmental pollution, which is more suitable for mass production.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. An aluminum alloy comprising:
an aluminum alloy substrate; and
an oxide layer formed on a surface of the aluminum alloy substrate, wherein the oxide layer comprises an outer surface and an inner surface;
and wherein
the outer surface contains corrosion pores having an average diameter of about 200 nm to about 2000 nm; and
the inner surface contains nanopores having an average diameter of about 10 nm to about 100 nm.

2. The aluminum alloy according to claim 1, wherein the corrosion pores have an average diameter of about 200 nm to about 1000 nm, and the nanopores have an average diameter of about 20 nm to about 80 nm.

3. The aluminum alloy according to claim 2, wherein the corrosion pores have an average diameter of about 400 nm to about 1000 nm, and the nanopores have an average diameter of about 20 nm to about 60 nm.

4. The aluminum alloy according to claim 1, wherein the corrosion pores have a depth of about 0.5 μm to about 9.5 μm.

5. The aluminum alloy according to claim 1, wherein the corrosion pores are communicated with the nanopores.

6. The aluminum alloy according to claim 1, wherein the oxide layer has a thickness of about 1 μm to about 10 μm.

7. The aluminum alloy according to claim 1, wherein the nanopores have a depth of about 0.5 μm to about 9.5 μm.

8. A method of preparing an aluminum alloy, comprising:
S1: anodizing a surface of an aluminum alloy to form an oxide layer on the surface, in which the oxide layer is formed with nanopores having an average diameter of about 10 nm to about 100 nm;
S2: immersing the resulting aluminum alloy in step S1 in an etching solution, to form corrosion pores in an outer surface of the oxide layer, in which the corrosion pores have an average diameter of about 200 nm to about 2000 nm.

9. The method according to claim 8, wherein anodizing the surface of the aluminum alloy substrate comprises:
providing the aluminum alloy as an anode in a H₂SO₄ solution with a concentration of about 10 wt % to about 30 wt %; and
electrolyzing the aluminum alloy at a temperature of about 10° C. to about 30° C. at a voltage of about 10V to about 100V for about 1 min to about 40 min to form the oxide layer with a thickness of about 1 μm to about 10 μm on the surface of the aluminum alloy substrate.

10. The method according to claim 8, wherein the etching solution comprises a solution being corrosive to the oxide layer.

11. The method according to claim 8, wherein step S2 comprises repeatedly immersing the resulting aluminum alloy in step S1 in an etching solution, each immersing last for about 1 min to about 60 min, and cleaning the aluminum alloy with water after each immersing.

12. The method according to claim 11, wherein step S2 comprises repeatedly immersing the resulting aluminum alloy in step S1 in an etching solution for about 2-10 times.

13. The method according to claim 8, further comprising pretreating the aluminum alloy substrate; wherein, the pretreatment includes: oil removing, a first washing with water, alkali etching, a second washing with water, neutralizing, and a third washing with water.

14. An aluminum alloy resin composite comprising:
an aluminum alloy part, comprising an aluminum alloy substrate; and an oxide layer formed on a surface of the aluminum alloy substrate, wherein the oxide layer comprises an outer surface and an inner surface, and wherein the outer surface contains corrosion pores having an average diameter of about 200 nm to about 2000 nm; and
the inner surface contains nanopores having an average diameter of about 10 nm to about 100 nm; and
a resin part, which is fixed to the surface of the aluminum ally part, wherein part of the resin part is filled in the nanopores and corrosion pores of the aluminum alloy part.

15. The composite according to claim 14, wherein the resin part is formed by a thermoplastic resin.

16. The composite according to claim 15, wherein the thermoplastic resin includes a main resin and a polyolefin resin.

17. The composite according to claim 16, wherein the main resin includes polyphenylene ether and polyphenylene sulfide, and the polyolefin resin has a melting point of about 65° C. to about 105° C.

18. The composite according to claim 17, wherein in the main resin, the weight ratio of polyphenylene ether to polyphenylene sulfide is about 3:1 to about 1:3.

19. The composite according to claim 15, wherein the resin part further includes a filler; the filler comprises at least one of a fiber filler and a powder inorganic filler, the fiber filler includes at least one selected from the group consisting of fiberglass, carbon fiber and polyamide fiber, and the powder inorganic filler includes at least one selected from the group consisting of silica, talc, aluminum hydroxide, magnesium hydroxide, calcium carbonate, magnesium carbonate, glass and kaolin.

20. A method of preparing an aluminum alloy-resin composite, comprising:
S1: anodizing a surface of an aluminum alloy to form an oxide layer on the surface, in which the oxide layer is formed with nanopores having an average diameter of about 10 nm to about 100 nm;
S2: immersing the resulting aluminum alloy in step S1 in an etching solution, to form corrosion pores in an outer surface of the oxide layer, in which the corrosion pores have an average diameter of about 200 nm to about 2000 nm; and
S3: injection molding a resin onto the surface of the resulting aluminum alloy substrate in step S2 in a mold to obtain the aluminum alloy-resin composite.
